(19) United States
(12) Patent Application Publication
(10) Pub. No.: US 2008/0245826 A1
(43) Pub. Date: Oct. 9, 2008

(54) Method and Silo for Storage and Accumulation of Plastic Bottles or Empty Lightweight Containers

(76) Inventor: Lino Lanfranchi, Collecchio (PR) (IT)

Correspondence Address: YOUNG & THOMPSON, 209 Madison Street, Suite 500, ALEXANDRIA, VA, 22314, US

(21) Appl. No.: 12/092,271

(22) PCT Filed: Oct. 25, 2006
(86) PCT No.: PCT/EP06/10278

§ 371 Date: May 1, 2008

(51) Int. Cl. B67D 3/00; B65D 88/64

(52) U.S. Cl. 222/564; 222/1

(57) ABSTRACT

The invention finds application in the field of systems for storage of containers, particularly plastic bottles or empty lightweight containers. The invention relates to a silo (1) or box of the type including a closed structure (1a) having a container loading inlet in an upper portion, either at the top or at the side thereof, and a bottom (1b) having at least one unloading outlet, which can be controlled by suitable elements, including a plurality of sheets (21) for dividing the structure (1a) into a plurality of bottle guiding channels (22) in alternating directions to define a zigzag path with respect to the bottle falling direction, the sheets (21) being mounted and held under tension by fixing rollers (13), return rollers (13a) and tension rollers (14); the arrangement of the rollers (13, 13a, 14) being adapted to allow positioning of the sheets (21) according to the above desired zigzag path.

This invention relates to a method and a silo for storage and accumulation of empty plastic bottles and lightweight containers.

In plastic bottle filling processes, it is known to form plastic bottles by preform blow molding or extrusion methods; the bottles so formed may be conveyed either directly to filling lines or to storage silos, wherefrom they are later withdrawn to be transferred to such filling lines.

Bottles are usually manufactured in factories that are specialized in the manufacture of plastic items and then shipped in boxes in a bulk storage arrangement.

As a result, the silo is used where storage and/or stocking are required to assure a certain accumulation volume in case of shutdown.

Storage silos or boxes are made up of parallelepipeds of square or rectangular cross section, which are open at their tops and closed at their bottom by outfeed conveyors and by movable walls for bottle unloading.

Prior art storage silos, as described in International Publication WO00/64787, have a plurality of strips or ribbons attached to the side walls in such an arrangement as to form a plurality of parallel planar grids, disposed on a flat surface.

Prior art drawbacks are associated to the arrangement of strips, which form bridges, whereby bottles do not fall during unloading of the box or silo after removal of the bottom wall.

Another Patent GB 14281 describes the storage receptacles of loose or friable substances comprising a plurality of rigid inclined channels, which, if used with very light and voluminous plastic bottles, can cause the bottles to get stuck.

The object of this invention is to obviate the above drawbacks and to provide a storage method that facilitates bottle fall.

This object is fulfilled by using sheets oriented longitudinally in the bottle falling direction, in a zigzag arrangement, which define a plurality of corresponding guiding channels and allow proper stacking and fall of containers.

The advantages achieved thanks to the method and apparatus for carrying out such method consist in preventing the formation of bridges which hinder the fall of bottles, as well as bottle crushing during storage.

These objects and advantages are achieved by the silo and method for accumulation and storage according to this invention, which is characterized by the annexed claims.

These and other features will be more apparent from the following description of a few embodiments, which are shown by way of example and without limitation in the accompanying drawings, in which:

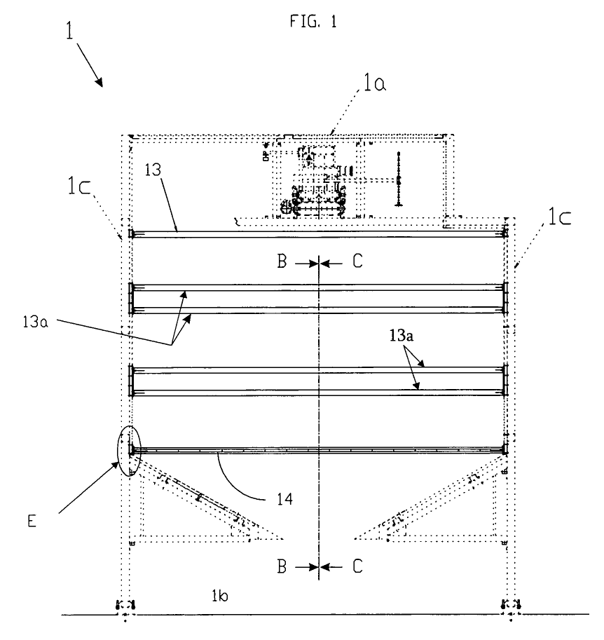

FIG. 1 is a front center view of a silo with sheets according to this invention;

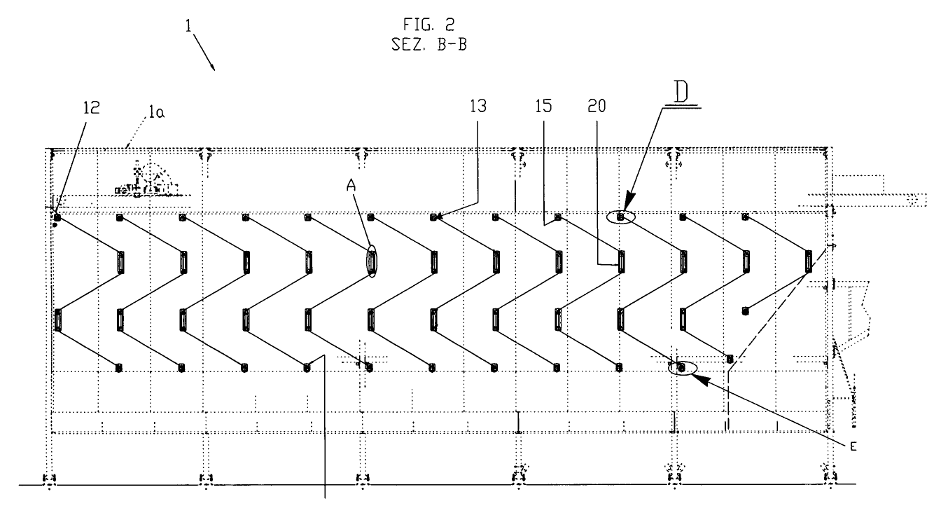

FIG. 2 is a B-B section of the silo of FIG. 1;

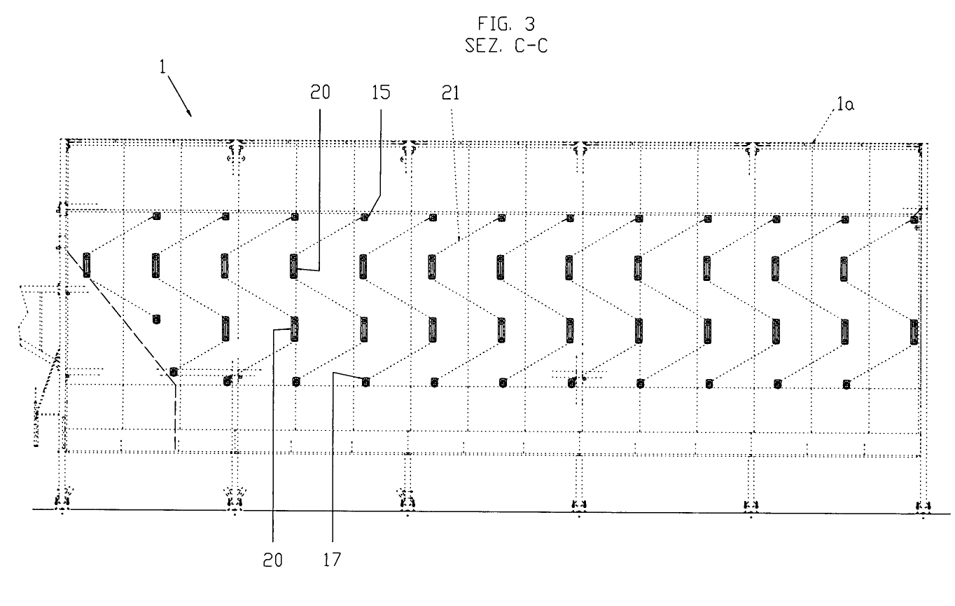

FIG. 3 is a C-C section of the silo of FIG. 1;

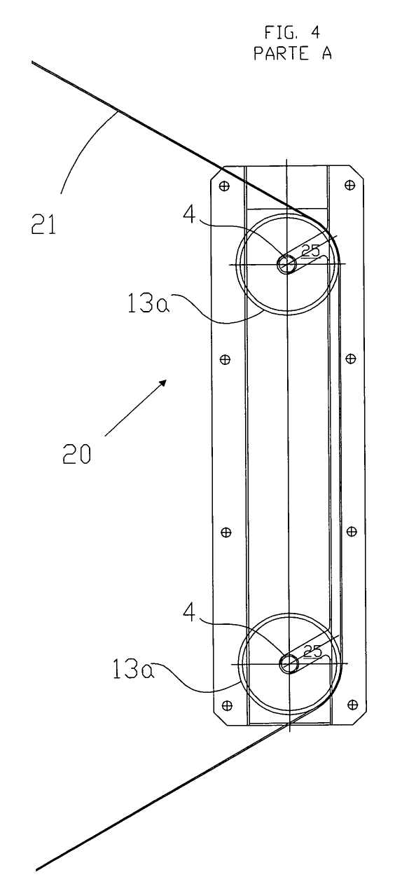

FIG. 4 is a detail view of a sheet return roller;

FIG. 5 is a detail view of a sheet fixing roller;

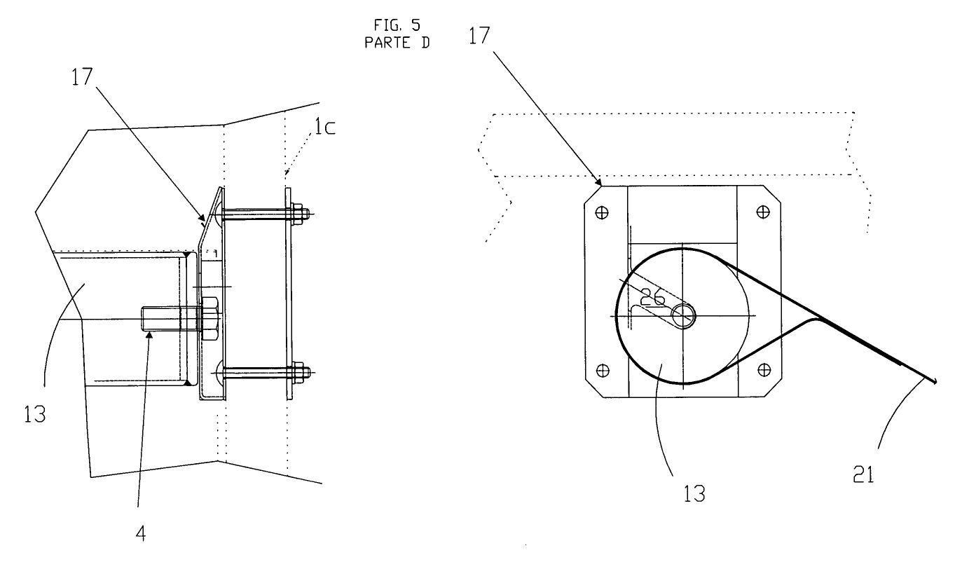

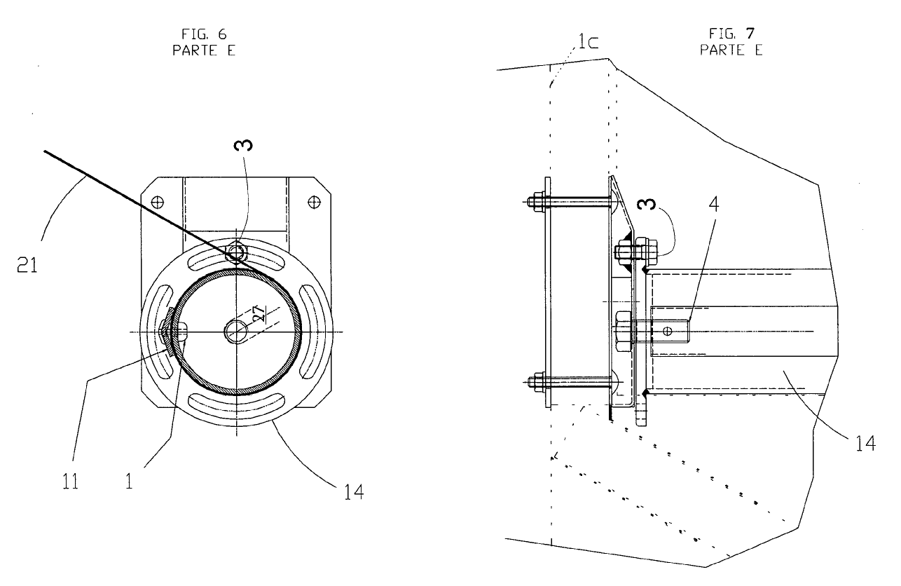

FIGS. 6 and 7 are detail views of a tension roller.

Referring to FIGS. 1, 2 and 3, numeral 1 generally designates a silo for accumulation of plastic bottles or empty containers in general, which is defined by a closed structure 1a that forms the frame of the apparatus.

Such structure 1a shall have a container loading inlet, which is usually located in an upper portion and a hopper-type open bottom 1b, which is equipped with means for controlling its opening, to allow discharge of stacked bottles.

The above inlet may be situated either in a top or in a side position, provided it is located in an upper portion of the structure 1a, as bottles in the silo are acted upon by gravity in that they are introduced from the top and discharged from the lower portion of the silo 1, which is designated by 1b. Fixing rollers 13, 13a and 14 are fixed between the side walls 1c of the structure; their purpose is to allow tensioning of a sheet 21 which is appropriately attached thereto as explained below.

The rollers are shown in detail in FIGS. 4, 5, 6 and 7 and more precisely: FIG. 4 shows the support 20 on which two return rollers 13a are connected, FIGS. 5 and 6 show the support 15 and its respective sheet 21 fixing roller 13, FIGS. 6 and 7 show the arrangement for tensioning the sheet 21 by means of the tension roller 14.

The rollers 13, 13a and 14 are disposed substantially perpendicular to the plane of the side walls 1c.

The sheets 21 are adapted to divide the structure into a plurality of bottle guiding channels 22 in alternating directions to define a so-called “zigzag” path with respect to the direction of bottles as they fall into the silo 1.

The fixing rollers 13 and the return rollers 13a are in such a position as to assist said sheet positioning in the predetermined zigzag arrangement.

Each tension roller 14 is preferably connected to one end of the sheet 21, although such rollers may be obviously placed on both ends of the sheet 21 without departure from the scope of the invention, by providing identical tension rollers 14 instead of the fixing rollers 13. Each sheet 21 is joined to a fixing roller 13, a tension roller 14 and at least one return roller 13a. It is shown in this example that two return rollers 13a are provided for each sheet 21, to allow an additional direction change for the sheet. The return rollers 13a, which are shown in detail in FIG. 4, are connected to a dual support 20, in which two grooves 20a are formed for receiving a means 4, more specifically a screw, connected to each end of each roller 13a. The grooves have such an orientation that, as the sheet 21 is tensioned, the rollers cannot come out of these receptacles.

The same arrangement is used for fixing and tension rollers 13, 14, the grooves 26 and 27 being suitably positioned as shown in FIGS. 5 and 7.

The fixing roller 13 is held by a support 15 and the tension roller 14 is held by a support 17, both being attached to the side walls 1c, as shown in FIGS. 6 and 8. The above tension roller 14 has a blind rivet 1 and a plate 11 for fixing the sheet 21; furthermore, tensioning may be controlled by adjusting the angle of rotation of the roller 14 and fixing the latter by the screw 3.

In this embodiment, the rollers 13, 13a and 14 are received in the guides 25, 26, 27 by means of screws 4 connected at their ends: this arrangement may be obviously replaced by technical equivalents without departure from the inventive scope.

The number of rollers 13a will obviously depend on the height of the silo 1 and on the number of direction changes to be imparted to the sheet 21. For clarity, the term “zigzag” as used herein to define the path formed by the sheets 21 and the guiding channels 22 is intended to mean that, as the bottle falls from the top to the bottom of the silo 1, it is also moved sideways alternately to the right and to the left or vice versa, and so on to the end of the sheet 21.

As mentioned above with reference to FIG. 4, the sheet 21 is returned in its direction by the two return rollers 13a. The above arrangement may be susceptible to changes, particularly the two return rollers 13a may be replaced by a single roller of greater diameter, e.g. 4 times the size of the illustrated roller 13a.

This will simplify the construction of the silo 1 and possibly reduce its costs.

1. A method for storage and accumulation of plastic bottles or empty lightweight containers in a silo which comprises a closed structure having a container loading inlet in an upper portion, either at the top or at the side thereof, and a bottom having at least one unloading outlet, which can be controlled by suitable means, characterized in that it provides the division of the structure into multiple bottle guiding channels, said channels being conformed in alternating directions to define a zigzag path with respect to the bottle falling direction and said channels being defined by sheets that are fixed and tensioned on corresponding rollers.

2. A silo for storage and accumulation of plastic bottles or empty lightweight containers, of the type comprising a closed structure (1a) having a container loading inlet in an upper portion, either at the top or at the side thereof, and a bottom (1b) having at least one unloading outlet, which can be controlled by suitable means, characterized in that it comprises a plurality of sheets (21) for dividing the structure (1a) into a plurality of bottle guiding channels (22) in alternating directions to define a zigzag path with respect to the bottle falling direction, said sheets (21) being mounted and held under tension by fixing rollers (13), return rollers (13a) and tension rollers (14); the arrangement of said rollers (13, 13a, 14) being adapted to allow positioning of the sheets (21) according to said desired zigzag path.

3. A silo as claimed in claim 2, characterized in that each sheet (21) is joined to a fixing roller (13), a tension roller (14) and at least one direction return roller (13a).

4. A silo as claimed in claim 2, characterized in that the ends of the rollers (13, 13a, 14) are connected to means (4) adapted to be received in corresponding grooves (25, 26, 27) formed on the supports (15, 17, 20).

5. A silo as claimed in claim 4, characterized in that said means (4) are screws or equivalent systems.

6. A silo as claimed in claim 3, characterized in that the grooves (25, 26, 27) are arranged in such a manner as to stabilize their respective roller upon tensioning of the sheet (21) by the tension roller (14).

7. A silo as claimed in claim 3, characterized in that the sheet (21) is subjected returned by a single roller of greater diameter instead of two return rollers (13a).
